(19) United States
(12) Patent Application Publication
(10) Pub. No.: US 2019/0212849 A1
(43) Pub. Date: Jul. 11, 2019

(54) METHOD AND APPARATUS THAT DETECT DRIVER INPUT TO TOUCH SENSITIVE DISPLAY

(71) Applicant: GM GLOBAL TECHNOLOGY OPERATIONS LLC, Detroit, MI (US)

(72) Inventor: Vipul M. Patel, NORTHVILLE (US)

(21) Appl. No.: 15/865,982

(22) Filed: Jan. 9, 2018

(51) Int. Cl. G06F 3/041

(52) U.S. Cl. CPC G06F 3/0412; B60K 2350/1028; G06F 3/0416

(57) ABSTRACT

A method and apparatus that determine whether an occupant of a seat is operating a touch screen. The method includes detecting a signal received through an antenna embedded in a seat, determining whether the detected signal is generated by an input to a touch screen, and outputting information indicating an occupant of the seat is operating the touch screen if the determining determines that the detected signal is generated by an input to a touch screen.

### INTRODUCTION

Apparatuses and methods consistent with exemplary embodiments relate to detecting inputs. More particularly, apparatuses and methods consistent with exemplary embodiments relate to indirectly detecting input into a touch display.

### SUMMARY

One or more exemplary embodiments provide a method and an apparatus that detect an input into a touch screen and determine a location corresponding to a source of the input. More particularly, one or more exemplary embodiments provide a method and an apparatus that determine whether an occupant of a driver's seat is operating a touch screen device and take action according to the determination.

According to an aspect of an exemplary embodiment, a method for determining whether an occupant of a seat is operating a touch screen is provided. The method includes detecting a signal received through an antenna embedded in a seat, determining whether the detected signal is generated by an input to a touch screen, and outputting information indicating an occupant of the seat is operating the touch screen if the determining determines that the detected signal is generated by an input to a touch screen. The touch screen may be part of a mobile device.

The detecting may detect the signal received h antenna embedded in a seat through a body of the occupant of the seat.

The method may also include determining a location of the seat where the signal is received through the antenna embedded in the seat, and outputting a notification warning a driver not to operate a touch screen device if the location of the seat is a driver's seat.

The method may also include determining a frequency of the detected signal, and outputting the notification warning the driver not to operate the touch screen device if the location of the seat is the driver's seat and the determined frequency exceeds a preset threshold frequency.

The method may also include determining a location of the seat where the signal is received through the antenna embedded in the seat, determining a frequency of the detected signal, and determining whether a vehicle is moving or about to about to move, frequency of the detected signal, and the outputting the notification may include warning the driver not to operate a touch screen device if the location of the seat is the driver's seat, the determined frequency exceeds a preset threshold frequency, and the vehicle is moving or about to move.

The method may also include disabling the touch screen if the location of the seat is the driver's seat, the determined frequency exceeds a preset threshold frequency, and the vehicle is moving or about to move.

The determining whether the detected signal is generated by the input to the touch screen may include comparing an amplitude of the detected signal to a predetermined threshold amplitude.

The determining whether the detected signal is generated by the input to the touch screen may include comparing a signature of the detected signal to a pre-stored signature corresponding to mobile device.

According to an aspect of exemplary embodiment, an apparatus that determines whether an occupant of a seat is operating a touch screen is provided. The apparatus includes an antenna configured to receive a signal, at least one memory comprising computer executable instructions; and at least one processor configured to read and execute the computer executable instructions. The computer executable instructions may cause the at least one processor to detect a signal received through the antenna, determine whether the detected signal is generated by an input to a touch screen, and output information indicating an occupant of the seat is operating touch screen if the determining determines that the detected signal is generated by an input to a touch screen. The touch screen may be part of a mobile device.

The antenna may be embedded in the seat. The antenna embedded in the seat may be configured to receive a signal through a body of the occupant of the seat.

The computer executable instructions may cause the at least one processor to determine a location of the seat where the signal is received through the antenna embedded in the seat, and output a notification warning a driver not to operate a touch screen device if the location of the seat is a driver's seat.

The computer executable instructions may cause the at least one processor to determine a frequency of the detected signal, and output the notification warning the driver not to operate the touch screen device if the location of the seat is the driver's seat and the determined frequency exceeds a preset threshold frequency.

The computer executable instructions may cause the at least one processor to determine a location of the seat where the signal is received through the antenna embedded in the seat, determine a frequency of the detected signal, determine whether a vehicle is moving or about to about to move, frequency of the detected signal, and output the notification by warning the driver not to operate a touch screen device if the location of the seat is the driver's seat, the determined frequency exceeds a preset threshold frequency, and the vehicle is moving or about to move.

The computer executable instructions may cause the at least one processor to disable the touch screen if the location of the seat is the driver's seat, the determined frequency exceeds a preset threshold frequency, and the vehicle is moving or about to move.

The computer executable instructions may cause the at least one processor to determine whether the detected signal is generated by the input to the touch screen by comparing an amplitude of the detected signal to a predetermined threshold amplitude.

The computer executable instructions may cause the at least one processor to determine whether the detected signal is generated by the input to the touch screen by comparing a signature of the detected signal to a pre-stored signature corresponding to mobile device.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 shows a block diagram of an apparatus that determines whether an occupant of a seat is operating a touch screen according to an exemplary embodiment;

FIG. 2 shows a flowchart for a method of determining whether an occupant of a seat is operating a touch screen according to an exemplary embodiment;

FIG. 3 shows an illustration of a seat including an apparatus that determines whether an occupant of a seat is operating a touch screen according to an aspect of an exemplary embodiment; and

FIGS. 4A-4C show illustrations of detecting an input into a touch screen device according to various aspects of an exemplary embodiment

### DETAILED DESCRIPTION OF EXEMPLARY EMBODIMENTS

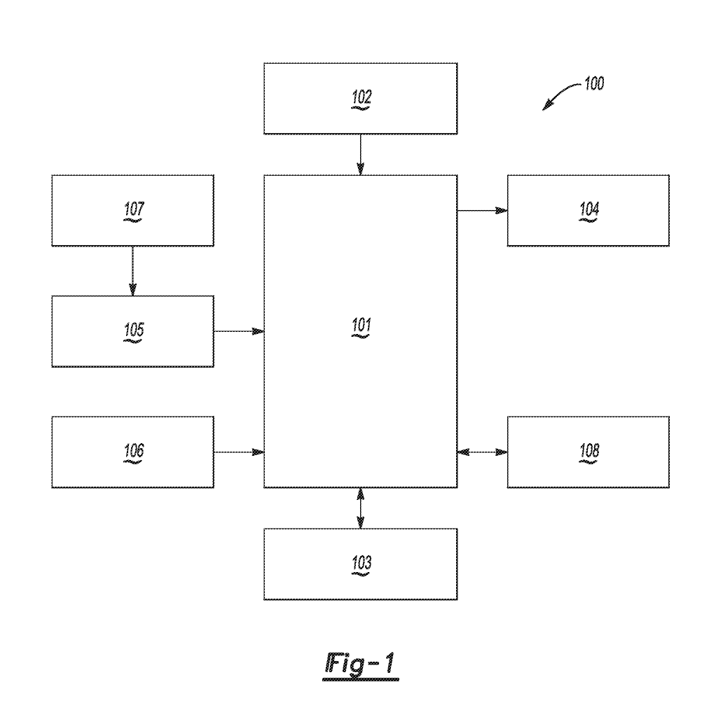

An apparatus and method and apparatus that determines whether an occupant of a seat is operating a touch screen will now be described in detail with reference to FIGS. 1-4C of the accompanying drawings in which like reference numerals refer to like elements throughout,

The following disclosure will enable one skilled in the art to practice the inventive concept. However, the exemplary embodiments disclosed herein are merely exemplary and do not limit the inventive concept to exemplary embodiments described herein. Moreover, descriptions of features or aspects of each exemplary embodiment should typically be considered as available for aspects of other exemplary embodiments.

It is also understood that where it is stated herein that a first element is “connected to,” “attached to,” “formed on,” or “disposed on” a second element, the first element may be connected directly to, formed directly on or disposed directly on the second element or there may be intervening elements between the first element and the second element, unless it is stated that a first element is “directly” connected to, attached to, formed on, or disposed on the second element. In addition, if a first element is configured to “send” or “receive” information from a second element, the first element may send or receive the information directly to or from the second element, send or receive the information via a bus, send or receive the information via a network, or send or receive the information via intermediate elements, unless the first element is indicated to send or receive information “directly” to or from the second element.

Throughout the disclosure, one or more of the elements disclosed may be combined into a single device or into one or more devices. In addition, individual elements may be provided on separate devices.

Occupants of vehicles may operate touch screen devices when sitting inside of a vehicle. The touch screen devices may be mobile devices such as laptops, tablets, cell phones, or may be part of the vehicle's infotainment system. While operation of certain touch screen devices is permitted or desirable under certain circumstances, an operator of a vehicle (i.e., a driver) operating a touch screen device while operating a vehicle may be distracted from operating the vehicle. However, it is not always possible or it may be difficult to determine which of the occupants of the vehicle is operating the touch screen and take the appropriate action.

An exemplary embodiment may address this issue by determining whether an occupant is operating a touch screen and determining the seating position of the occupant. In particular, an exemplary embodiment uses a device embedded in a seat of a vehicle to detect the operation of a touch screen and determine that an occupant of the seat is operating the touch screen. In response to this determination, an exemplary embodiment may control to disable the touch screen device or output a notification warning an occupant not to operate the touch screen device.

FIG. 1 shows a block diagram of an apparatus that determines whether an occupant of a seat is operating a touch screen 100 according to an exemplary embodiment. As shown in FIG. 1, the apparatus that determines whether an occupant of a seat is operating a touch screen 100, according to an exemplary embodiment includes a controller 101, a power supply 102, a storage 103, an output 104, a touch input detector 105, a user input 106, a signal sensor 107, and a communication device 108. However, the apparatus that determines whether an occupant of a seat is operating a touch screen 100 is not limited to the aforementioned configuration and may be configured to include additional elements and/or omit one or more of the aforementioned elements. The apparatus that determines whether an occupant of a seat is operating a touch screen 100 may be implemented as part of a vehicle, as a standalone component, as a hybrid between an on vehicle and off vehicle device, or in another computing device.

The controller 101 controls the overall operation and function of the apparatus that determines whether an occupant of a seat is operating a touch screen 100. The controller 101 may control one or more of a storage 103, an output 104, a touch input detector 105, a user input 106, a signal sensor 107, and a communication device 108 of the apparatus that determines whether an occupant of a seat is operating a touch screen 100. The controller 101 may include one or more from among a processor, a microprocessor, a central processing unit (CPU), a graphics processor, Application Specific Integrated Circuits (ASICs), Field-Programmable Gate Arrays (FPGAs), state machines, circuitry, and a combination of hardware, software and firmware components.

The controller 01 may be configured to send and/or receive information from one or more of the storage 103, the output 104, the touch input detector 105, the user input 106, the signal sensor 107, and the communication device 108 of the apparatus that determines whether an occupant of a seat is operating a touch screen 100. The information may be sent and received via a bus or network, or may be directly read or written to/from one or more of the storage 103, the output 104, the touch input detector 105, the user input 106, and the communication device 108 of the apparatus that determines whether an occupant of a seat is operating a touch screen 100. Examples of suitable network connections include a controller area network (CAN), a media oriented system transfer (MOST), a local interconnection network (LIN), a local area network (LAN), wireless networks such as Bluetooth and 802.11, and other appropriate connections such as Ethernet.

The power supply 102 provides power to one or more of the controller 101, the storage 103, the output 104, the touch input detector 105, the user input 106, and the communication device 108, of the apparatus that determines whether an occupant of a seat is operating a touch screen 100. The power supply 102 may include one or more from among a battery, an outlet, a capacitor, a solar energy cell, a generator, a wind energy device, an alternator, etc.

The storage 103 is configured for storing information and retrieving information used by the apparatus that determines whether an occupant of a seat is operating a touch screen 100. The storage 103 may be controlled by the controller 101 to store information received from the touch input detector 105 and to retrieve the stored information. The storage may store information indicating whether an occupant of a seat is operating a touch screen, information corresponding to a position of or location of the seat of the occupant operating the touch screen, information on a preset threshold frequency of a signal corresponding an type of operation on a touch screen device (e.g., a texting, etc.), information on a number of times a signal is detected within predetermined period of time, information on whether a vehicle is moving, a predetermined threshold amplitude for determining whether a touch screen device is being operated, and a pre-stored signature corresponding to mobile device to a signal from a touch screen device and identification information of the touch screen device associated with the pre-stored signature. In addition, the storage 103 may also include the computer instructions configured to be executed by a processor to perform the functions of the apparatus that determines whether an occupant of a seat is operating a touch screen 100.

The storage 103 may include one or more from among floppy diskettes, optical disks, CD-ROMs (Compact Disc-Read Only Memories), magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, cache memory, and other type of media/machine-readable medium suitable for storing machine-executable instructions.

The output 104 outputs information in one or more forms including: visual, audible and/or haptic form. The output 104 may be controlled by the controller 101 to provide outputs to the user of the apparatus that determines whether an occupant of a seat is operating a touch screen 100. The output 104 may include one or more from among a speaker, an audible transducer, a display, a centrally-located display, a head up display, a windshield display, a haptic feedback device, a vibration device, a tactile feedback device, a tap-feedback device, a holographic display, an instrument light, an installment panel display, a center stack display, a rear view minor display, a side view mirror display, an indicator light, etc.

According to one example, the output 104 may be one or more from among a center stack display, a side mirror display, or instrument panel display a rear view mirror display. The output 104 may be configured to output an image or notification that warns an operator of the touch screen device not to operate the touch screen device or may output a notification indicating that the touch screen device has been disabled. In addition, the output 104 may output the notification including one or more from among an audible notification, a light notification, and a display notification.

The user input 106 is configured to provide information and commands to the apparatus that determines whether an occupant of a seat is operating a touch screen 100. The user input 106 may be used to provide user puts, etc., to the controller 101. The user input 106 may include one or more from among a touchscreen, a keyboard, a soft keypad, a button, a motion detector, a voice input detector, a microphone, a camera, a trackpad, a mouse, a touchpad, etc. The user input 106 may be configured to receive a user input to acknowledge or dismiss the notification output by the output 104.

The touch input detector 105 may be configured to detect a touch input via a signal received from the signal sensor 107. The touch input detector 105 may be part of the controller 101 or a standalone component. The touch input detector analyzes the signal input received from the signal sensor 107 and determines whether the signal corresponds to a signal generated when an occupant of a seat corresponding to the signal sensor is operating a touch screen. The touch input detector 105 may output information indicating whether an occupant of a seat s operating a touch screen, information corresponding to a position of or location of the seat of the occupant operating the touch screen, information on a preset threshold frequency of a signal corresponding an type of operation on a touch screen device (e.g., a texting, etc.).

The signal sensor 107 may be a metal plate, antenna or other device configured to detect a signal generated by a touch screen device. The signal sensor 107 may indirectly detect the signal generated by the touch screen device, for example, through the body of an operator (i.e., a person) of the touch screen device. The signal sensor may be embedded in a seat occupied by the operator or other interior panel or object in a vehicle. For example, a steering wheel, a center console, a door panel, etc.

The communication device 108 may be used by apparatus that determines whether an occupant of a seat is operating a touch screen 100 to communicate with various types of external apparatuses according to various communication methods. The communication device 108 may be used to send/receive information indicating whether an occupant of a seat is operating a touch screen, information corresponding to a position of or location of the seat of the occupant operating the touch screen, information on a preset threshold frequency of a signal corresponding an type of operation on a touch screen device texting, etc.), information on a number of times a signal is detected within predetermined period of time, information on whether a vehicle is moving, a predetermined threshold amplitude for determining whether a touch screen device is being operated, and a pre-stored signature corresponding to mobile device to a signal from a touch screen device and identification information of the touch screen device associated with the pre-stored signature. The communication device 108 may be used to send/receive the aforementioned information to/from various components of apparatus that determines whether an occupant of a seat s operating a touch screen 100.

The communication device 108 may include various communication modules such as one or more from among a telematics unit, a broadcast receiving module, a near field communication (NFC) module, a GPS receiver, a wired communication module, or a wireless communication module. The broadcast receiving module may include a terrestrial broadcast receiving module including an antenna to receive a terrestrial broadcast signal, a demodulator, and an equalizer, etc. The NEC module is a module that communicates with an external apparatus located at a nearby distance according to an NFC method. The GPS receiver is a module that receives a GPS signal from a GPS satellite and detects a current location. The wired communication module may be a module that receives information over a wired network such as a local area network, a controller area network (CAN), or an external network. The wireless communication module is a module that is connected to an external network by using a wireless communication protocol such as IEEE 802.11 protocols, WiMAX, Wi-Fi or IEEE communication protocol and communicates with the external network. The wireless communication module may further include a mobile communication module that accesses a mobile communication network and performs communication according to various mobile communication standards such as 3^{rd} generation (3G), 3^{rd} generation partnership project (3GPP), long-term evolution (LTE), Bluetooth, EVDO, CDMA, GPRS, EDGE or ZigBee.

According to an example, the controller 101 of the apparatus that determines whether an occupant of a seat is operating a touch screen 100 may be configured to detect signal received through the antenna, determine whether the detected signal is generated by an input to a touch screen, and output information indicating an occupant of the seat is operating the touch screen if the determining determines that the detected signal is generated by an input to a touch screen. The antenna may be embedded in the seat and may be configured to receive a signal through a body of the occupant of the seat. The touch screen may be part of a mobile device such as a cell phone, tablet, or laptop.

According to an example, the controller 101 of the apparatus that determines whether an occupant of a seat is operating a touch screen 100 may be configured to determine a location of the seat where the signal is received through the antenna embedded in the seat, and output a notification warning a driver not to operate a touch screen device if the location of the seat is a driver's seat. In addition, the controller 101 of the apparatus that determines whether an occupant of a seat is operating a touch screen 100 may be configured to determine a frequency of device if the location of the seat is the driver's seat and the determined frequency exceeds a preset threshold frequency.

According to an example, the controller 101 of the apparatus that determines whether an occupant of a seat is operating a touch screen 100 may be configured to determine a location of the seat where the signal is received through the antenna embedded in the seat, determine a frequency of the detected signal, determine whether a vehicle is moving or about to about to move, frequency of the detected signal, and output the notification further comprises warning the driver not to operate a touch screen device if the location of the seat is the driver's seat, the determined frequency exceeds a preset threshold frequency, and the vehicle is moving or about to move. The controller 101 may also be configured to disable the touch screen if the location of the seat is the driver's seat, the determined frequency exceeds a preset threshold frequency, and the vehicle is moving or about to move.

According to an example, the controller 101 of the apparatus that determines whether an occupant of a seat is operating a touch screen 100 may be configured to determine whether the detected signal is generated by the input to the touch screen by comparing an amplitude of the detected signal to a predetermined threshold amplitude.

According to an example, the controller 101 of the apparatus that determines whether an occupant of a seat is operating a touch screen 100 may be configured to determine whether the detected signal is generated by the input to the touch screen comprises comparing a signature of the detected signal to a pre-stored signature corresponding to mobile device.

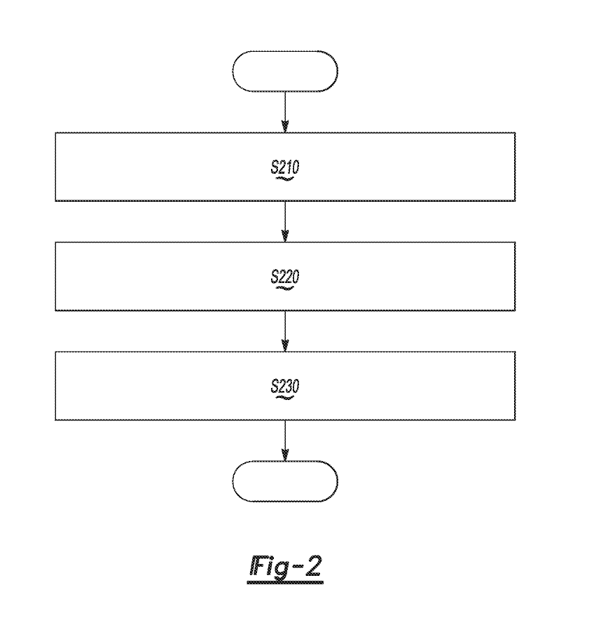

FIG. 2 shows a flowchart for a method of determining whether an occupant of a seat is operating touch screen according to an exemplary embodiment. The method of FIG. 2 may be performed by the apparatus that determines whether an occupant of a seat is operating a touch screen 100 or may be encoded into a computereadable medium as instructions that are executable by a computer to perform the method.

Referring to FIG. 2, a signal is detected through a sensor embedded in a seat or chair in operation S210. The sensor may be an antenna, metal plate, etc. The signal may be a signal generated by an occupant of a seat touching a touch screen device. The seat may be a vehicle seat such as a driver's seat.

In operation S220, it is determined whether the detected signal was generated by an input to a touch screen device. For example, the signal may travel from the touch screen device through the body of an occupant of a vehicle seat to the sensor or antenna. The received signal may then be analyzed by comparing its frequency, amplitude, signature to pre-stored or predetermined information corresponding to frequency, amplitude or signature of a signal. The result of the comparison may be used to determine whether the signal was generated by an input to a touch screen device.

If the detected signal was generated by an input to a touch screen device, information indicating that an occupant of the seat where the signal is detected may be output. For example, the information may be output using methods described with respect to the output 106. In addition, the information may be used to disable the touch screen device or display warnings if the seat where the touch screen operation is detected corresponds to a seat of an operator of a vehicle.

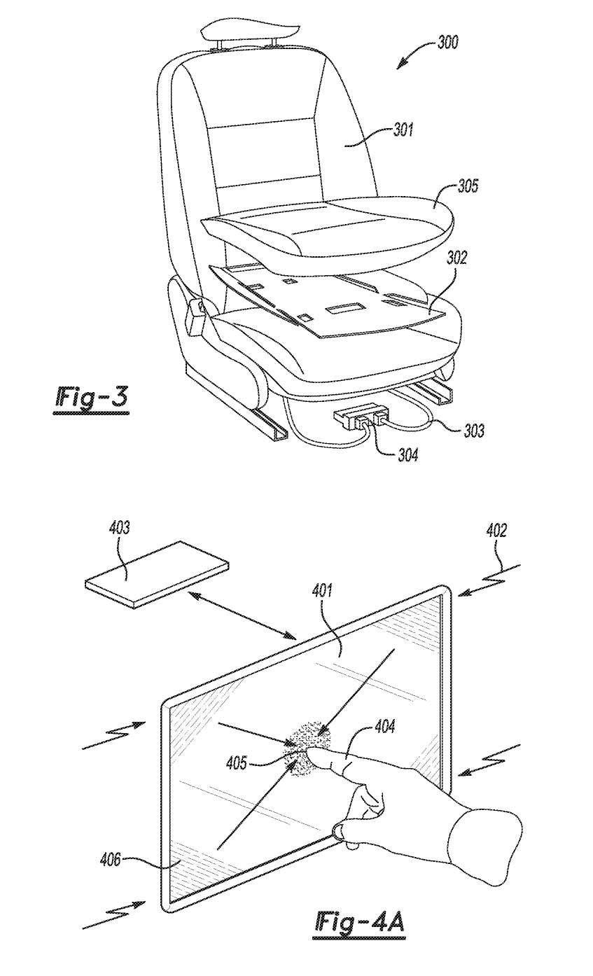

FIG. 3 shows an illustration of a seat including an apparatus that determines whether an occupant of a seat is operating a touch screen according to an aspect of an exemplary embodiment.

Referring to FIG. 3, the seat 300 may include an antenna 302 (e.g., a metal plate) embedded in between a seat top 301 and a seat cushion 305. The antenna 302 may receive a signal that travels through a wire 303 to the detector 304. The detector 304 may process the signal to determine whether the signal corresponds to an input to a touch screen device or may simply convert the signal and transmit or send information corresponding to the signal to a controller 101 or other computing device that can analyze the signal to determine whether the signal corresponds to an input to a touch screen device.

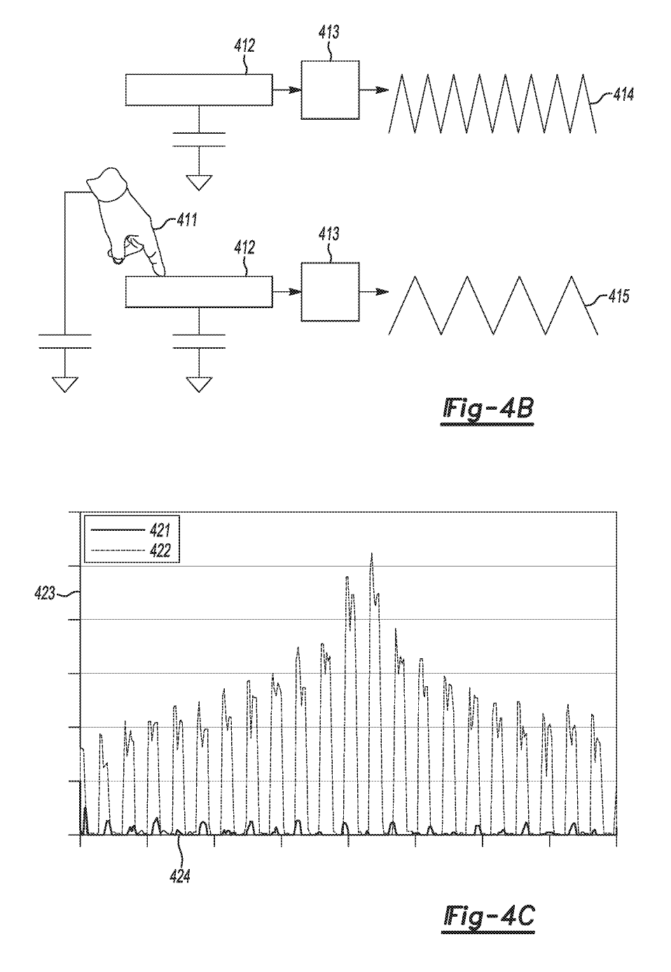

FIGS. 4A-4C shows illustrations of detecting an input into a touch screen device according to various aspects of an exemplary embodiment.

Referring to FIG. 4A, an operator of a touch screen device 401 may draw current from a uniform electric field 406 of a small voltage that is applied to the touch screen 401 by touching the screen with a body part 404 such as finger or hand. The controller 403 may detect the touch 405 and determine where the touch has occurred on the touch screen device. During this process, a signal travels through the body part 404 and may be detected by a sensor located in a seat occupied by an operator of the touch screen device.

Referring to FIG. 4B, the hand 411 may have a capacitance that causes a waveform 414 generated by a touch screen device 413 to be altered to waveform 415 when the electrode 412 is touched by the hand. The difference in change in from waveform 414 to waveform 415 is used by the touch screen device 413 to detect the presence of a touch. This change may also be detected by a sensor in the seat occupied by an operator of a touch screen device.

Referring to FIG. 4C, examples of a signal level detected by an antenna or a sensor in the seat occupied by an operator of a touch screen device are shown. The x-axis 424 shows the frequency of the signal and the y-axis 423 shows the signal level. Signal 421 is detected by the sensor when an operator sitting in a seat is not operating a touch screen. Signal 422 is detected by the sensor when an operator sitting in a seat is operating a touch screen device. Signal 422 has a higher signal level and shows frequencies corresponding to the frequency output by the touchscreen device when compared to signal 421.

The processes, methods, or algorithms disclosed herein can be deliverable to/implemented by a processing device, controller, or computer, which can include any existing programmable electronic control device or dedicated electronic control device. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

One or more exemplary embodiments have been described above with reference to the drawings. The exemplary embodiments described above should be considered in a descriptive sense only and not for purposes of limitation. Moreover, the exemplary embodiments may be modified without departing from the spirit and scope of the inventive concept, which is defined by the following claims.

1. A method for determining whether an occupant of a seat is operating a touch screen, the method comprising:
detecting a signal corresponding to an electric field of a touch screen, the signal received through an antenna embedded in a seat;
determining whether the detected signal is generated by an input to a touch screen; and
outputting information indicating an occupant of the seat is operating the touch screen if the determining determines that the detected signal is generated by an input to a touch screen.

2. The method of claim 1, wherein the detecting detects the signal received by the antenna embedded in a seat through a body of the occupant of the seat.

3. The method of claim 1, further comprising:
determining a location of the seat where the signal is received through the antenna embedded in the seat; and
outputting a notification warning a driver not to operate a touch screen device if the location of the seat is a driver's seat.

4. The method of claim 3, further comprising determining a frequency of the detected signal; and
outputting the notification warning the driver not to operate the touch screen device if the location of the seat is the driver's seat and the determined frequency exceeds a preset threshold frequency.

5. The method of claim 1, further comprising determining a location of the seat where the signal is received through the antenna embedded in the seat, determining a frequency of the detected signal, and determining whether a vehicle is moving or about to about to move,
wherein the outputting the notification further comprises warning the driver not to operate a touch screen device if the location of the seat is the driver's seat, the determined frequency exceeds a preset threshold frequency, and the vehicle is moving or about to move.

6. The method of claim 5, further comprising disabling the touch screen if the location of the seat is the driver's seat, the determined frequency exceeds a preset threshold frequency, and the vehicle is moving or about to move.

7. The method of claim 1, wherein the determining whether the detected signal is generated by the input to the touch screen comprises comparing an amplitude of the detected signal to a predetermined threshold amplitude.

8. The method of claim 1, wherein the determining whether the detected signal is generated by the input to the touch screen comprises comparing a signature of the detected signal to a pre-stored signature corresponding to mobile device.

9. The method of claim 1, wherein the touch screen is part of a mobile device.

10. A non-transitory computer readable medium comprising computer executable instructions executable by a processor to perform the method of claim 1.

11. An apparatus that determines whether an occupant of a seat is operating a touch screen, the apparatus comprising:
an antenna configured to receive a signal;
at least one memory comprising computer executable instructions; and
at least one processor configured to read and execute the computer executable instructions, the computer executable instructions causing the at least one processor to:
detect a signal corresponding to an electric field of a touch screen, the signal received through the antenna;
determine whether the detected signal is generated by an input to a touch screen; and
output information indicating an occupant of the seat is operating the touch screen if the determining determines that the detected signal is generated by an input to a touch screen.

12. The apparatus of claim 11, wherein the antenna is embedded in the seat.

13. The apparatus of claim 11, wherein the antenna embedded in the seat is configured to receive a signal through a body of the occupant of the seat.

14. The apparatus of claim 11, wherein the computer executable instructions cause the at least one processor to determine a location of the seat where the signal is received through the antenna embedded in the seat, and output a notification warning a driver not to operate a touch screen device if the location of the seat is a driver's seat

15. The apparatus of claim 14, wherein the computer executable instructions cause the at least one processor to determine a frequency of the detected signal, and output the notification warning the driver not to operate the touch screen device if the location of the seat is the driver's seat and the determined frequency exceeds a preset threshold frequency

16. The apparatus of claim 11, wherein the computer executable instructions cause the at least one processor to determine a location of the seat where the signal is received through the antenna embedded in the seat, determine a frequency of the detected signal, determine whether a vehicle is moving or about to about to move, frequency of the detected signal, and output the notification further comprises warning the driver not to operate a touch screen device if the location of the seat is the driver's seat, the determined frequency exceeds a preset threshold frequency, and the vehicle is moving or about to move.

17. The apparatus of claim 11, wherein the computer executable instructions cause the at least one processor to disable the touch screen if the location of the seat is the driver's seat, the determined frequency exceeds a preset threshold frequency, and the vehicle is moving or about to move.

18. The apparatus of claim 11, wherein the computer executable instructions cause the at least one processor to determine whether the detected signal is generated by the input to the touch screen by comparing an amplitude of the detected signal to a predetermined threshold amplitude.

19. The apparatus of claim 11, wherein the computer executable instructions cause the at least one processor to determine whether the detected signal is generated by the input to the touch screen comprises comparing a signature of the detected signal to a pre-stored signature corresponding to mobile device.

20. The apparatus of claim 11, wherein the touch screen is part of a mobile device.
